(19) United States
(12) Patent Application Publication
(10) Pub. No.: US 2004/0219347 A1
(43) Pub. Date: Nov. 4, 2004

(54) Fabric Design Board, Kit and Method of Use

(76) Inventor: Wanda Hayes Eichler, Pigeon, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/250,231

(22) Filed: Jun. 16, 2003

Related U.S. Application Data
(60) Provisional application No. 60/320,156, filed on Apr. 30, 2003.

(51) Int. Cl. B32B 29/02; D05B 11/00

(52) U.S. Cl. 428/292.7; 428/102; 428/192; 442/320; 442/321; 442/324; 112/117

(57) ABSTRACT

A design board of the present invention includes a base sheet having at least one substantially flat surface and a contact surface member substantially the same size as the base sheet and coupled to the substantially flat surface. The design board of the present invention is capable of holding fabric in position on the contact surface member to aid in design and organization of fabric projects. The present invention also includes a method of using the design boards for quilting and a kit for storing several design boards to aid in organizing fabric projects.

### CROSS REFERENCE TO RELATED APPLICATIONS

This application claims priority to a provisional patent application serial No. 60/320,156 titled, “Fabric Design Board, Kit and Method of Use,” filed Apr. 30, 2003. The entire disclosure of serial No. 60/320,156 is incorporated herein by reference in its entirety.

### FIELD OF THE INVENTION

The present invention generally relates to a tool, kit and method to help design and organize a fabric design project, such as a quilting project, by providing a plurality of rigid, stackable, lightweight and inexpensive design boards with surface qualities that allow fabric materials to be held in place on the design board, and by providing a method of quilting using the design boards, and a kit for storage of the design boards.

### DISCUSSION OF THE PRIOR ART

There are various quilting and sewing planners and tools available in the art designed to improve the efficiency of fabric projects, and otherwise provide better management of fabric projects. For instance, some quilting planners provide a surface for the user to draw out the block layout of a quilt. This type of planner may provide an erasable surface to allow reuse of the device. Others provide grid lines on the erasable surface to assist in providing the markings of the quilt block design. Still others may include quilting clamps, which hold layers of quilting materials together while stitching. One fabric project assisting device available in the art is the Sew E-Z Board. This device provides a padded and grid-lined surface and also has heat resistance capabilities for use when ironing directly on the surface of the board.

Although there may be tools available in the art to assist fabric projects, there are no known tools presently available that provide a tool, kit or method of use, designed specifically for placing and holding fabric, such as quilt block pieces. Thus there is a desire and need in the art to provide a design tool that includes a work surface capable of holding fabric in position on the tool to enable viewing and storing of the designs. There is also a need in the art to provide an improved method of quilting using the design tool and a system or kit for storing work in process.

### SUMMARY OF THE INVENTION

Accordingly, the present invention provides a simple, inexpensive design tool, kit and method. The tool includes a surface specially designed to hold fabrics on the tool, such as quilt pieces, and enable viewing of designs prior to sewing.

In one embodiment of the present invention, a design board includes a base sheet having at least one substantially flat surface and a contact surface member substantially the same size as the base sheet and coupled to the substantially flat surface. The surface contact member is also configured to hold fabric.

In another embodiment of the present invention a method of quilting using at least one design board having a base sheet and a contact surface member coupled to the base sheet, includes the steps of: placing quilt pieces on the at least one design board; arranging the quilt pieces to form a design block; and sewing the quilt pieces together and placing on the at least one design board.

In still another embodiment of the present invention a kit for organizing and storing a fabric project includes a plurality of design boards having a base sheet and a contact surface member. The base sheet has at least one substantially flat surface and the contact surface member is substantially the same size as the base sheet and coupled to the substantially flat surface and configured to hold fabric. A carrying device and a cover board are also included.

Other features of the present invention will become more apparent to persons having ordinary skill in the art to which the present invention pertains from the following description and claims taken in conjunction with the accompanying figures.

### BRIEF DESCRIPTION OF DRAWINGS

The foregoing features, as well as other features, will become apparent with reference to the description and figures below, in which like numerals represent like elements, and in which:

FIG. 1 is a front perspective view of a design board of the present invention;

FIG. 2 is a sectional view of a section cut along line 2-2 in FIG. 1;

FIG. 3 illustrates a design board of the present invention in use with quilt pieces held thereon;

FIG. 4 illustrates several design boards in a stack; and

FIG. 5 illustrates a kit for storing several design boards.

### DETAILED DESCRIPTION

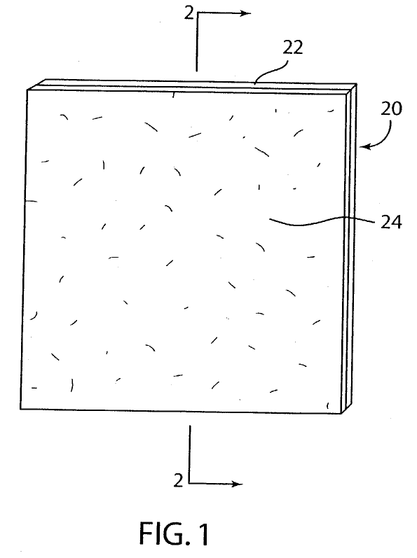

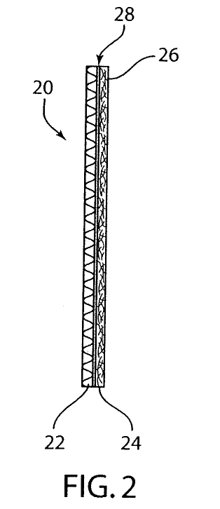

The present invention generally relates to a fabric design tool designed to improve the efficiency of fabric projects, such as quilting and sewing, by organizing and assisting with the design of the project. As shown in FIGS. 1 and 2, a design board 20 of the present invention includes a substantially rigid base sheet 22 and a contact surface member 24. Base sheet 22 may be constructed of a light weight material such as corrugated cardboard, plastic or any other suited material providing the necessary rigidity. Base sheet 22 as shown in the figures may include at least one substantially flat surface 26 and may be generally square shaped. In other embodiments, base sheet 22 could be configured to adopt different shapes, such as a triangle, rectangle or circle (not shown), depending on the particular fabric project or other needs of the user. Further, base sheet 22 may be constructed in various sizes. For example, in one embodiment, base sheet 22 is a 25.4 cm (10 inch) square to accommodate a typical quilt block size. In another embodiment, base sheet 22 may be a 35.56 cm (14 inch) square.

Contact surface member 24 may be constructed of a felt or felt-like material, which provides characteristics that allow fabric material, such as cotton or other textiles, to cling to contact surface member 24. Other suitable materials may also be used that provide similar attraction properties. Additionally, contact surface member 24 may be a spray-on material providing a textured or frictional surface that provides the necessary characteristics to hold fabric thereon.

Contact surface member 24 should preferably be substantially the same size as base sheet 22 covering substantially all of substantially flat surface 26. Contact surface member 24 may be adhesively coupled to substantially flat surface 26 as shown by adhesion layer 28 in FIG. 2, or alternatively may be attached by other means known in the art. As stated above, contact surface 24 may alternatively be sprayed on to base sheet 22.

Contact surface member 24 provides a working surface for positioning fabrics, such as quilting pieces, and designing the fabric project. For purposes of illustration, a quilting project will be referred to for ease of understanding, but it is to be understood that design boards 20 may be used for many other fabric projects, such as sewing.

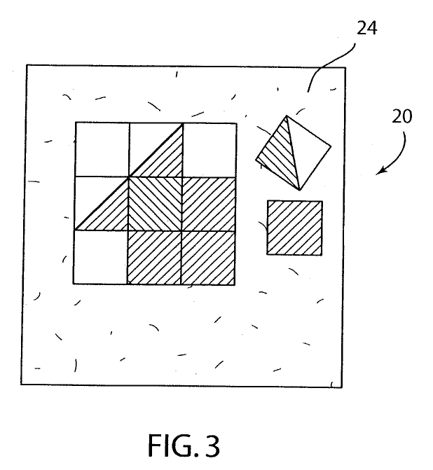

For quilting, design boards 20 provide a working surface for designing quilt blocks as a user cuts the quilting pieces. A separate design board 20 may be used for each quilting block. Quilting pieces, typically made of cotton and other like fabrics will cling to contact surface member 24 and be held in position. Quilt pieces may be moved around and rearranged until a desired design block is achieved (See FIG. 3). This enables the user to try different combinations of colors and fabrics and view and store the finished block design and/or its component fabric pieces before the user begins to sew the pieces together.

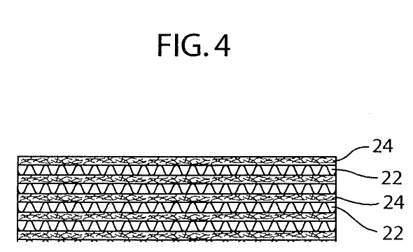

A user may assemble and then sew one block design at a time. Alternatively, a user may arrange quilt pieces and assemble several design blocks on separate design boards 20 and then later sew all the pieces of a given design block at one time. To aid in the sewing step of quilt making, a user may remove pieces from the design board 20 for sewing and then replace the sewn portion to the design board 20. This helps the user keep track of which rows and portions that have been sewn and clearly shows where to return the sewn portion to design board 20. Design board 20 provides the user with a lightweight, portable, and stackable fabric project aid (see FIG. 4). Thus, a user can assemble several block designs of a quilt on several design boards 20 and then stack the design boards 20 for storage until a later work session. Also, after sewing the quilt pieces together, a user may again stack the design boards 20 to move the stack to a pressing area to iron the sewn pieces. Each block design or pieces of a block design may be. pressed and then returned to its designated design board 20.

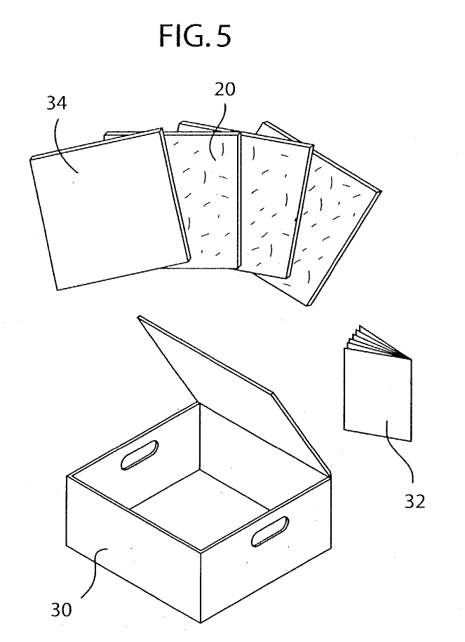

One embodiment of the present invention provides a kit as shown in FIG. 5. This embodiment provides a plurality of design boards 20, a cover board 34, a carrying device 30 and optionally an information or instruction sheet, leaflet or booklet 32. Carrying device 30 may include a carrying case such as a box or a carrying bag such as a 3 mil thick sealable plastic bag. Cover board 34 may be constructed with the same or similar materials as base sheet 22. Thus, cover board 34 does not include contact surface member 24. Cover board 34 is configured to be placed on top of a stack of design boards 20 to protect and hold the fabric that is positioned on the top design board 20 of a stack. The kit of the present invention allows easy, safe and convenient storage of several design boards 20.

The design board 20 of the present invention provides several benefits. One such benefit is the ability to stack the design boards 20 for storage until a later fabric project session. Another benefit is that design board 20 enables the user to stop a project at any point without loss of organization. The fabric pieces of the work in process will be held in place on design boards 20, regardless of whether they have been sewn or pressed. The design board 20 is also lightweight and portable and helps organize a fabric project. For instance, a user may work on a fabric project virtually anywhere, whether working on one design board 20 or several that are stacked. If the user is in a location having minimal space to work, the user may hold the stack of design boards 20 in their lap and shuffle through the design boards 20 to find a given design block that needs to be worked on. A user may also layout several design boards 20 on a surface such as a table or floor, to view the overall design of the project.

The present invention also includes an improved method of quilting using the design boards 20. There are several possible variations of the quilting method that can be practiced depending on the desire of the user.

A user may begin a quilting project by first arranging several quilt pieces on a design board 20 of the present invention. The user may arrange the quilt pieces until a desired first block design is achieved. For maximum efficiency, the user should repeat the design arrangement on several design boards 20 before moving to the next step of sewing. Alternatively, the user may begin sewing some or all of the quilt pieces of the first block design together, rather than continuing on to another design board 20.

If a user has arranged quilt pieces and formed several design blocks on several design boards 20, the user may then begin sewing the block design pieces together. To sew the block design pieces, the user removes at least two quilt pieces from the design board 20, sews the at least two pieces together into.a sewn unit and then returns the sewn unit to its previous position on design board 20. The user may choose to sew portions of a given design block at this point in the process, such as a row or rows of quilt pieces. Again, for maximum efficiency the user would sew some or all of the pieces on all of the design boards 20 before moving to the step of pressing. Nevertheless, the user may elect to sew one or some of the block designs and then proceed to the pressing step for those blocks, rather than waiting until all sewing is complete. For the pressing step, the user takes the design boards 20, with the sewn design block or sewn portions of the design block, to a press station to press the sewn pieces. At any step, the user may conveniently place the design boards 20 in the carrying device 30 for transport or for storage if they must discontinue working on the project. As completed blocks are removed from design board 20 to be sewn into the finished quilt, the user may reuse design boards 20 for additional designs or projects.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A design board, comprising:
a base sheet having at least one substantially flat surface;
a contact surface member substantially the same size as said base sheet and coupled to said substantially flat surface; and
wherein said contact surface member is configured to hold fabric.

2. The design board of claim 1, wherein said base sheet is constructed of cardboard.

3. The design board of claim 1, wherein said contact surface member includes felt-like material.

4. The design board of claim 1, wherein said base sheet is substantially square shaped.

5. The design board of claim 1, wherein said base board is approximately 25.4 cm×25.4 cm square.

6. The design board of claim 1, wherein said base board is approximately 35.56 cm×35.56 cm square.

7. The design board of claim 1, wherein said contact surface member is adhesively coupled to said base sheet.

8. A method of quilting using at least one design board having a base sheet and a contact surface member coupled to the base sheet, comprising the steps of:
placing quilt pieces on the at least one design board;
arranging the quilt pieces to form a design block;
sewing the quilt pieces together and placing on the at least one design board.

9. The method of claim 8, further including the step of:
pressing the sewn quilt pieces; and
placing the sewn quilt pieces on the design board.

10. The method of claim 8, wherein the at least one design board includes at least two design boards and further including the step of:
stacking the at least two design boards; and
storing the design boards for later use.

11. A kit for organizing and storing a fabric project, comprising:
a plurality of design boards including a base sheet and a contact surface member, the base sheet having at least one substantially flat surface and the contact surface member substantially the same size as the base sheet coupled to the substantially flat surface and configured to hold fabric;
a carrying device; and
a cover board.
